(19) United States
(12) Patent Application Publication
(10) Pub. No.: US 2017/0116637 A1
(43) Pub. Date: Apr. 27, 2017

(54) PREDICTING ONLINE CONTENT PERFORMANCE

(71) Applicant: LinkedIn Corporation, Mountain View, CA (US)

(72) Inventors: Michael Alan Davis, Santa Clara, CA (US); Allen Pang, San Jose, CA (US); Diana Luu, Toronto (CA)

(21) Appl. No.: 14/921,752

(22) Filed: Oct. 23, 2015

(51) Int. Cl. G06Q 30/02

(52) U.S. Cl. CPC G06Q 30/0242; G06Q 30/0277

(57) ABSTRACT

A machine may be configured to predict the performance of online content. For example, the machine accesses data pertaining to delivery of a campaign. The campaign may be an online ad campaign including one or more ads to be delivered to one or more users. The machine identifies a stage of the campaign at a particular time. The identifying of the stage may be based on the data pertaining to the delivery of the campaign. The stage corresponds to a particular period in a life of the campaign. The machine generates a predicted revenue value for the campaign based on the stage of the campaign. The predicted revenue value represents an estimated total revenue deliverable during the campaign. The machine causes a presentation of the predicted revenue value in a user interface of a device associated with an administrator.

### TECHNICAL FIELD

The present application relates generally to the processing of data, and, in various example embodiments, to systems, methods, and computer program products for predicting the performance of online content.

### BACKGROUND

Online advertising debuted as a new advertising medium in the mid-1990s to allow advertisers to promote their products and services on the Internet. Publishers (e.g., website owners) ran online ads on their web sites for the advertisers. The earliest ad serving software utilized by the publishers allowed the display of banner ads in the browsers of the users visiting the publishers' websites. In time, other types of online advertising have appeared, such as sponsored ads, affiliate ads, pay-per-click ads, etc.

As online advertising became more prevalent, certain methods for selling online advertising became more common. The Cost Per Thousand (also “CPM”) model was one of the earliest forms of selling online advertising and was based on an agreed rate for every one thousand impressions served. The Cost Per Click (also “CPC) model was often used and allowed publishers to charge advertisers a higher rate when users clicked on ads.

In addition to selling ad spots on their websites, the publishers are responsible to some degree for managing the advertising on their web sites. Generally, the publisher ensures that the online advertising campaign is set up properly and is receiving the online traffic promised to the advertiser. An online advertising campaign (also “advertising campaign” or “campaign”) may specify one or more types of advertising products (also “ad products”) to be delivered during a campaign delivery period and a collection of common settings that a creative or a group of creatives associated with an ad product should abide by. A creative is a form of advertising material, such as a banner, Hyper Text Markup Language (HTML) form, Flash file, etc. Common creative types include Graphics Interchange Format (GIF), Joint Photographic Experts Group (JPEG), Java, HTML, Flash, or streaming audio/video.

Generally, the publisher also provides reports regarding the advertising campaign to the advertiser. At the most basic level, reporting is used to determine overall campaign performance. An advertiser may want to know how many impressions and/or clicks a campaign received, and how it performed on specific parts of a site.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a revenue predicting system, according to some example embodiments;

FIG. 3 is a flowchart illustrating a method for predicting the revenue value of an advertising campaign, according to some example embodiments;

FIG. 4 is a flowchart illustrating a method for predicting the revenue value of an advertising campaign, and representing additional steps of the method illustrated in FIG. 3, according to some example embodiments;

FIG. 5 is a flowchart illustrating a method for predicting the revenue value of an advertising campaign, and representing step 306 of the method illustrated in FIG. 3 in more detail and an additional step of the method illustrated in FIG. 3, according to some example embodiments;

FIG. 6 is a flowchart illustrating a method for predicting the revenue value of an advertising campaign, and representing additional steps of the method illustrated in FIG. 5, according to some example embodiments;

FIG. 7 is a flowchart illustrating a method for predicting the revenue value of an advertising campaign, and representing step 502 of the method illustrated in FIG. 5 in more detail and additional steps of the method illustrated in FIG. 5, according to some example embodiments;

FIG. 8 is a flowchart illustrating a method for predicting the revenue value of an advertising campaign, and representing steps 304 and 504 of the method illustrated in FIG. 6 in more detail and additional steps of the method illustrated in FIG. 6, according to some example embodiments;

FIG. 9 is a flowchart illustrating a method for predicting the revenue value of an advertising campaign, and representing steps 304 and 504 of the method illustrated in FIG. 5 in more detail and additional steps of the method illustrated in FIG. 5, according to some example embodiments;

FIG. 10 is a diagram illustrating a user interface displaying filters applicable to campaign data of one or more campaigns, and a revenue report for one or more campaigns, according to some example embodiments;

FIG. 11 is a block diagram illustrating a mobile device, according to some example embodiments; and

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems for predicting a revenue value of an advertising campaign associated with a customer are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Publishers of online content may provide online content to consumers of online content via web sites associated with the publishers or with third parties. The online content may include online advertising. Sometimes, a publisher of online content provides online advertising on behalf of an advertising customer (also “customer” or “advertiser”). Both the publisher and the advertiser may be interested in various performance aspects of the online content (e.g., the online advertising). Examples of such performance aspects are the number of impressions, the number of clicks, one or more revenue-related values associated with the delivery of certain online content, etc. In some instances, the publisher, the advertiser, or both, are interested in obtaining predictions related to various aspects of the performance of the online content.

Generally, in online advertising sales, a publisher delivers online advertising to users before the publisher can recognize the revenue corresponding to the delivered advertising. For example, a publisher and an advertiser agree to the sale of 1,000 impressions at $1.00 per impression to be delivered between Jan. 1, 2015 and Jan. 31, 2015. The publisher may be required to deliver 1,000 impressions to users of the publisher's web site before the publisher earns $1,000.

One of the realities of online advertising is that problems may arise in the course of an online advertising campaign (also “ad campaign” or “campaign”). For example, unforeseen circumstances may result in the campaign not delivering as many instances of an ad product (e.g., impressions) during the campaign delivery period as was originally agreed upon. It is not uncommon for a delivered online ad revenue (e.g., the revenue that corresponds to the instances of an ad product that were served (or delivered) to viewers of the publisher's web site) to fall short of a booked revenue (e.g., the price agreed upon by the advertiser and publisher) for the campaign. It may be beneficial to the publisher to utilize a revenue predicting system for forecasting a revenue value associated with a campaign and representing a revenue value predicted to result from a predicted delivery of online advertising included in the campaign. Although capturing the entire booked revenue for a campaign may sometimes be challenging, the revenue predicting system may assist the publisher in maximizing the delivery of the online advertising agreed upon with the customer and, therefore, maximizing the revenue delivered to the publisher.

Further, the revenue predicting system may facilitate the visualization of revenue and revenue risk trends. In some example embodiments, the visualization of revenue and revenue risk trends includes an act or a process of interpreting in visual terms or of putting into visible form revenue metrics or trends, and revenue risk trends. The visualization of revenue and revenue risk trends may facilitate a better understanding of the various revenue-related and risk-related metrics, the minimization of the risk of revenue loss, and, ultimately, the maximization of the revenues delivered to the publisher.

According to some example embodiments, the predicting of the revenue value that may result from running the campaign may be based on a stage in the life of the campaign, an input received from persons familiar with the progress of the campaign, or both.

In some example embodiments, the revenue predicting system accesses data pertaining to delivery of a campaign. The campaign is an online ad campaign including one or more ads to be delivered to one or more users (e.g., members of a Social Networking Service (SNS)). Specific members may be targeted to receive specific online advertising based on information about the members provided by the members to the social networking service (also “SNS”) or derived by the SNS based on member-provided data, such as membership profile data, social graph data, or member activity and behavior data.

The revenue predicting system also identifies a stage of the campaign at a particular time. The stage of the campaign corresponds to a particular period in the life of the campaign. The revenue predicting system generates, using one or more hardware processors, a predicted revenue value for the campaign. The generating of the predicted revenue value may be based on the stage of the campaign. The predicted revenue value represents an estimated total revenue deliverable during the campaign. The revenue predicting system may also cause a presentation of the predicted revenue value in a user interface of a device. The device may be associated with an administrator (e.g., a campaign manager, a member of an ads operations group, etc.).

In some example embodiments, the life of a campaign may be divided into a number of stages: a pre-start stage, a post-start and pre-delivery stage, a delivering stage, a delivery paused stage, a delivery post-pause stage, and an end stage. The campaign may be in a particular stage at a particular time. The predicted revenue value may be different at different stages in the life of the campaign. Various revenue prediction models may be used to predict the revenue associated with the campaign based on the particular stage of the campaign. The revenue predicting system may identify, based on the data pertaining to the delivery of the campaign, a revenue prediction model that corresponds to the particular stage that the campaign is in at a particular time. Based on the identified revenue prediction model, the revenue predicting system may generate the predicted revenue value for the campaign.

In certain example embodiments, various changes pertaining to the campaign may indicate the campaign transitioning from one stage to another stage. For example, after the advertiser and publisher sign a contract pertaining to an ad campaign, the ad campaign enters a first stage, the pre-start stage of the campaign that represents the time between the signing of the contract and the time for starting performance under the contract. As delivery of the ads included in the campaign starts, the campaign enters the second stage, the post-start date and pre-delivery stage of the campaign. During the progress of the campaign, the data pertaining to the delivery of the campaign is being updated (e.g., by an ad serving system). For example, the ad serving system records how many instances of an ad have been delivered during a particular day and to what users. In some instances, the revenue predicting system accesses the updated data pertaining to the delivery of the campaign. Based on the updated data, the revenue predicting system determines that the campaign has entered a further stage of the campaign (e.g., the delivery stage). Based on the determining that the campaign has entered the further stage, the revenue predicting system adjusts the predicted revenue value in real time.

According to some example embodiments, the predicting of the revenue value that may result from running the campaign may be based on input received from persons familiar with the progress of the campaign. The revenue predicting system may receive a status input pertaining to a status of the campaign at the stage from the device associated with an administrator. The administrator may be a user of the device who is associated with or manages the campaign, or is authorized to view information pertaining to the revenue and revenue-at-risk of the campaign, such as an Account Executive, a Campaign Manager, a Vice-President of Sales, a Chief Executive Officer, etc. In some instances, the status input is provided by the administrator to identify a reason for a delay of delivery of the one or more ads included in the campaign. The generating of the predicted revenue value for the campaign may further be based on the status input.

In various example embodiments, the revenue predicting system, based on the stage of the campaign, identifies one or more status input options pertaining to the status of the campaign at the stage. One or more of the stages of the campaign may have a particular set of possible states that describe a campaign in a respective stage. For example, if a campaign is behind schedule with respect to starting delivering ads, the revenue predicting system identifies, based on the campaign being in the post-start and pre-delivery stage, a number of status input options corresponding to possible reasons for the delivery delay.

The revenue predicting system may also cause a presentation of the one or more status input options in the user interface of the device associated with the administrator. According to the example above, the revenue predicting system causes the presentation of the number of status input options corresponding to the possible reasons for the delivery delay in the user interface. In some instances, the status input options are displayed in a pull-down menu in the user interface. The receiving of the status input may include receiving a selection, by the administrator, of the status input from the one or more status input options presented in the user interface of the device.

Consistent with certain example embodiments, based on the status input, the revenue predicting system classifies the campaign into a category. In some instances, the category represents the reason for a delay in the delivery of the campaign. The revenue predicting system may also cause a presentation of a reference to the campaign in association with the category in the user interface of the device.

The predicted revenue value may, in some instances, include the sum of an actually delivered revenue value determined based on one or more instances of an ad actually delivered to the users during an expired time of the delivery time, and a future revenue value associated with the remainder of the life of the campaign. The future revenue value may be generated based on historical ad delivery data for a similar campaign, a campaign classification, a pacing of the campaign, or a suitable combination thereof. A similar campaign may be a campaign for delivery of the same type of ad product, a campaign for a particular geographical region, or a combination of both. The pacing of the campaign may be a rate of delivering a campaign over a particular period of time.

Table 1 below illustrates example reasons for the delay or non-delivery of ads included in a campaign.

TABLE 1
Example reasons for non-delivery of ad products.

| Risk Classification | Description |
|---|---|
| Cancelled | Canceled line item (e.g., campaign or deal) |
| Pushed/Re-allocated | Revenue pushed into a future quarter or |
| | moved to a different product |
| Late creative | No creative/Partial creative |
| Contract awaiting internal | Contract held up with CBA/Legal/Revenue |
| Contract awaiting external | Contract waiting on client approval |
| Internal system issues/ | Various internal issues |
| capabilities | |
| Pending internal approval | Waiting on internal creative approval |
| Pending external approval | Waiting on client to approve ad product |
| | mock |
| No risk - Will drop on time | 100% sure the ad product will drop on time |

The revenue predicting system may facilitate the identifying of one or more reasons why certain ad products are not being delivered to users of the publisher's web site. The revenue predicting system may also facilitate the collaborating among a group of people managing an account associated with the advertiser to prioritize time and effort in order to address the identified reasons for non-delivery and to maximize the delivery of the sold advertising during the delivery period.

In addition, because the revenue predicting system is scalable, it may facilitate the monitoring of predicted revenue values associated with a large number of campaigns. In some example embodiments, the monitoring of the predicted revenue values associated with the campaigns includes ranking of a plurality of campaigns based on various factors (e.g., the predicted revenue value associated with each of the campaigns), generating of various reports pertaining to the campaigns, as well as generating of action reminders for the teams managing particular campaigns.

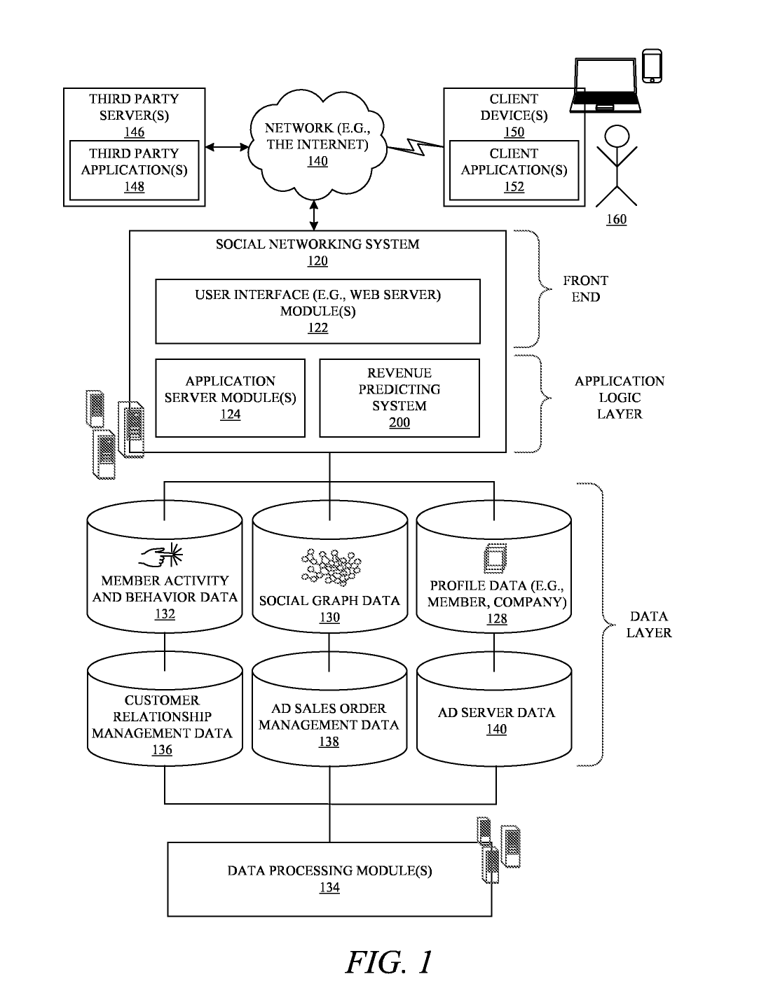

An example method and system for predicting online advertising revenue may be implemented in the context of the client-server system illustrated in FIG. 1. As illustrated in FIG. 1, the revenue predicting system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive advertising targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124.

In some example embodiments, a data aggregating engine for aggregating data pertaining to advertising revenues and risks may be implemented with one or more application server modules 124. For example, the data aggregating engine may select and aggregate data associated with a sale of online advertising to a customer (e.g., an advertiser) and/or delivery of online advertising to targeted users, such as an online ad sales order, a booked revenue value associated with the customer, a description of an advertising campaign, a product identifier of an ad product included in the advertising campaign, identifiers of targeted users, or the number of instances of delivered ad products. In some instances, this and other types of data pertaining to sales and deliveries of online advertising may be stored in the customer relationship management (CRM) database 136, ad sales order management database 138, ad server database 140, or another database. The aggregated data may be used by a revenue predicting system 200 to predict a likely revenue delivery value associated, for example, with a customer, advertising campaign, or ad product, and to determine a revenue value at risk of non-delivery to the targeted users and the reasons for the non-delivery among other things. The aggregated data may also be used by the revenue predicting system 200 to facilitate the visualization of online advertising revenue trends. For example, the revenue predicting system 200 may, based on data pertaining to advertising revenues and risks, generate revenue-related graphs to illustrate revenue trends or revenue risk trends associated with an advertising product or with an advertising campaign that includes one or more advertising products. Of course, other applications and services may be separately embodied in their own application server modules 124. As illustrated in FIG. 1, social networking system 120 may include the revenue predicting system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, CRM data, ad sales order management data, or ad server data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers of a large-scale distributed storage and processing framework, such as Hadoop servers, for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

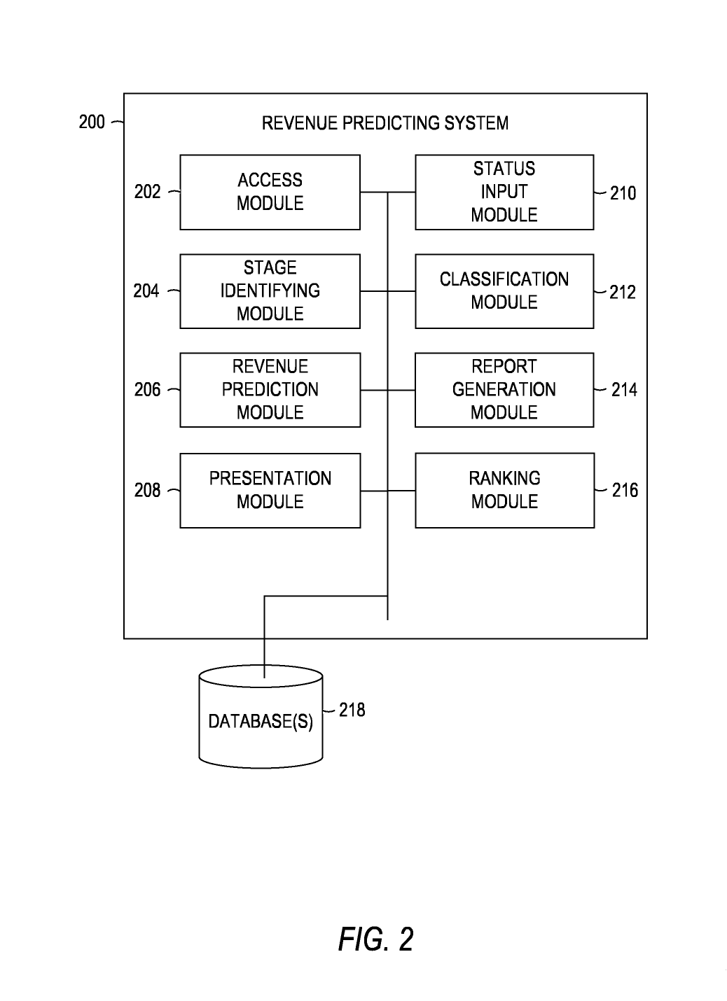

FIG. 2 is a block diagram illustrating components of the revenue predicting system 200, according to some example embodiments. As shown in FIG. 2, the revenue predicting system 200 includes an access module 202, a stage identifying module 204, a revenue prediction module 206, a presentation module 208, a status input module 210, a classification module 212, a report generation module 214, and a ranking module 216, all configured to communicate with each other (e.g., via a bus, shared memory, or a switch).

According to some example embodiments, the access module 202 accesses (e.g., receives) data pertaining to delivery of a campaign. The campaign is an online ad campaign including one or more ads to be delivered to one or more users (e.g., members of the SNS). The data pertaining to the delivery of the campaign may, in some instances, be stored in a record of a database (e.g., database 218). The data pertaining to the delivery of the campaign may include pre-delivery, delivery, and post-delivery information pertaining to one or more instances of one or more ads included in the campaign. Examples of such information are an identifier of a creative corresponding to the one or more ads, a campaign identifier, a contract date, a time to start performance under the contract, times of actual delivery of the one or more ads, identifiers of the users to whom the ads were delivered, a time of pausing the delivery of the campaign, a time of re-starting the delivery of the campaign, various contract terms, various revenue-related values pertaining to the one or more instances of the one or more ads (e.g., a booked revenue value, periodic revenue delivery targets, actually delivered revenue values, etc.)

In one example embodiment, the access module 202 accesses revenue booking data associated with a customer and identifying a revenue amount booked for delivering ads during a campaign delivery period (also a “life of the campaign”). In another example embodiment, the access module 202 accesses a daily delivered revenue value for each past date of the advertising campaign delivery period, the daily delivered revenue value corresponding to one or more instances of the ad product delivered as part of the campaign. In a further example embodiment, the access module 202 accesses a daily delivered revenue value that corresponds to a sum of revenue values for one or more ads delivered during a particular day. In yet a further example embodiment, the access module 202 accesses a forecast daily revenue value for each future date of the campaign delivery period. The forecast daily revenue value may correspond to one or more instances of an ad product (e.g., a displayed ad, a Sponsored Update, an InMail, etc.) forecast to be delivered at a future date as part of the campaign.

The stage identifying module 204 identifies a stage of the campaign at a particular time. The stage corresponds to a particular period in a life of the campaign. Examples of campaign stages are a pre-start stage, a post-start and pre-delivery stage, a delivering stage, a delivery paused stage, a delivery post-pause stage, and an end stage. The stage of the campaign may be identified based on the data pertaining to the delivery of the campaign. For example, based on the access module 202 accessing a record of a database that includes the data pertaining to the delivery of the campaign, the stage identifying module 204 determines that a contract pertaining to the campaign has been signed (e.g., by representatives of the advertiser and the publisher), but the time for the start of performance is a future time. Based on this determination, the stage identifying module 204 determines that the campaign is in the pre-start stage.

According to another example, based on the access module 202 accessing the data pertaining to the delivery of the campaign, the stage identifying module 204 determines that the present time is a time subsequent to the performance start time for delivery of the campaign. The stage identifying module 204 also determines that there is no data indicating that one or more instances of the campaign ads have been delivered, in the data pertaining to the delivery of the campaign. Based on the determination that the present time is subsequent to the performance start time, and the determination that there is no data indicating that one or more ads included in the campaign have been delivered, the stage identifying module 204 determines that the campaign is in the post-start and pre-delivery stage.

According to yet another example, based on the access module 202 accessing a record of a database that includes the data pertaining to the delivery of the campaign, the stage identifying module 204 determines that one or more instances of the ads included in the campaign have been delivered to one or more users. Based on the determination that the one or more instances of the ads included in the campaign have been delivered to the one or more users, the stage identifying module 204 determines that the campaign is in the delivering stage.

According to a further example, based on the access module 202 accessing the data pertaining to the delivery of the campaign, the stage identifying module 204 determines that the delivery of one or more ads included in the campaign has been paused. Based on the determination that the delivery of the one or more ads has been paused, the stage identifying module 204 determines that the campaign is in the delivery paused stage. A campaign may be paused for various reasons, such as replacing one or more creatives, re-targeting the campaign to a different group of users, a re-negotiation of the contract, etc.

According to yet a further example, based on the access module 202 accessing the data pertaining to the delivery of the campaign, the stage identifying module 204 determines that the campaign is completed (e.g., the present time is subsequent to an end-of-campaign date). Based on the determination that the campaign is completed, the stage identifying module 204 determines that the campaign is in the end stage.

The revenue prediction module 206 generates a predicted revenue value for the campaign based on the stage of the campaign. The predicted revenue value represents an estimated total revenue deliverable during the campaign. Various revenue prediction models may be used to predict the revenue associated with the campaign based on the particular stage of the campaign. The revenue prediction module 206 may identify, based on the data pertaining to the delivery of the campaign, a revenue prediction model that corresponds to the particular stage that the campaign is in at a particular time. Based on the identified revenue prediction model, the revenue predicting system may generate the predicted revenue value for the campaign.

In certain example embodiments, the access module 202 accesses updated data pertaining to the delivery of the campaign. The update data may indicate the beginning of a time for performance (e.g., a time to start delivering ads) as specified in the contract between the advertiser and the publisher. Alternatively or additionally, the updated data may represent information pertaining to further instances of the ads included in the campaign being delivered to users. In some instances, the update data indicates that the campaign has been paused from delivering ads.

Based on the accessed updated data, the stage identifying module 204 determines that the campaign has entered a further stage of the campaign in the campaign delivery process. For example, the stage identifying module 204 may determine that the updated data indicates that an ad server has delivered one or more instances of an ad included in the campaign. Based on the determination that the ad server has delivered one or more instances of an ad included in the campaign, the stage identifying module 204 determines that the campaign has entered the delivering stage in the life of the campaign.

Based on the determining, by the stage identifying module 204, that the campaign has entered the further stage, the revenue prediction module 206 adjusts the predicted revenue value in real time. To adjust the predicted revenue value, the revenue prediction module 206 may identify a further revenue prediction model that corresponds to the further stage of the campaign, and, based on the further revenue prediction model, generate the predicted revenue value for the campaign.

In some example embodiments, the revenue prediction module 206 generates a revenue risk value for the campaign based on the booked revenue value for the campaign and the predicted revenue value for the campaign. In some instances, the revenue risk value corresponds to the difference between the booked revenue value for the campaign and the predicted revenue value for the campaign.

The presentation module 206 causes a presentation (e.g., a display) of the predicted revenue value in a user interface of a device associated with an administrator of the campaign (e.g., a campaign manager, an ads operations team member, etc.) The presentation module 206 may also cause a presentation of the revenue risk value associated with the campaign in the user interface of the device. The presentation module 206 may also cause a presentation of rankings, reports, action reminder, among other things, pertaining to the predicted revenue value, the revenue risk value, or both. The presentation module 206 may also cause a presentation of various revenue-related metrics (e.g., various types of information related to predicted revenue values or revenue risk values for various campaigns or customers). The presentation module 206 may also cause display of a revenue-related graph (e.g., a revenue booking graph, a delivered revenue graph, a forecast revenue graph, etc.) in the user interface of the device.

The status input module 210, receives a status input pertaining to a status of the campaign at the stage from the device associated with a campaign administrator. The status input may identify a reason for a delay of delivery of the one or more ads included in the campaign. The generating of the predicted revenue value for the campaign, by the revenue prediction module 206, may further be based on the status input received from the device of the campaign administrator. For example, a status input may indicate that a creative for the campaign has not been received from the advertiser. The revenue prediction module 206 generates the predicted revenue for the campaign based on the status input that indicates that the creative has not been received from the advertiser.

In some example embodiments, the status input module 210 identifies, based on the stage of the campaign, one or more status input options pertaining to the status of the campaign at the stage. Based on the identifying, by the status input module 210 of the one or more status input options pertaining to the status of the campaign at the stage, the presentation module 204 causes a presentation of the one or more status input options in the user interface of the device of the campaign administrator. The receiving of the status input, by the status input module 210, includes receiving a selection, by the campaign administrator, of the status input from the one or more status input options presented in the user interface of the device of the campaign administrator.

According to certain example embodiments, the status input module 210 receives a further status input pertaining to the status of the campaign from the device. Based on the further status input, the status input module 210 determines that a change in the status of the campaign has occurred. Based on the determining, by the status input module 210, that the change in the status of the campaign has occurred, the revenue prediction module 206 adjusts the predicted revenue value in real time according to the change of the status of the campaign.

The classification module 212 classifies the campaign into a category based on the status input. For example, a status input may indicate that a creative for the campaign has not been received from the advertiser. The classification module 212 may classify the campaign into the category “External Issues” based on the status input. Based on the classification of the campaign, the presentation module 208 causes a presentation of a reference to the campaign in association with the category in the user interface of the device. According to the example above, the presentation module 208 may cause the presentation of one or more references to one or more campaigns, including the campaign, that are classified to be delayed by external issues, in association with a reference to the category “External Issues.”

In some example embodiments, according to a revenue prediction model corresponding to the pre-start stage, the revenue prediction module 206 determines, based on data describing the campaign, a type of ad product (e.g., a type of ad such as Sponsored Updates, InMail, Displayed Ads, etc.) included in the campaign. The data describing the campaign may include details of the campaign such as the type of ads included in the campaign, the duration of the campaign, the geographical region where the campaign is to run, etc. The revenue prediction module 206 also determines, based on the data describing the details of the campaign, a geographical region associated with the campaign (e.g., a region where the campaign is to be run). Based on the type of campaign and the geographical region, the revenue prediction module 206 determines an average daily delivery value for a particular period of time (e.g., the last twenty-eight days) for one or more further campaigns associated with the type of ad product and the geographical region.

The generating of the predicted revenue value for the campaign based on the stage of the campaign may include generating the predicted revenue value for the campaign based on the average daily delivery value for the particular period of time. In some instances, the revenue prediction module 206 also determines, based on a status input received from the device of the administrator, that additional information is available with respect to the status of the campaign. The revenue prediction module 206 may adjust the generated predicted revenue value based on the received status input. For example, the status input indicates that, historically, creatives received from the advertiser associated with the campaign have been received late. Based on this status input, the revenue prediction module 206 may adjust the predicted revenue value. In some instances, the adjusted predicted revenue value may correspond to an average of the delivered revenue values for similar campaigns for the particular advertiser that also had late creatives.

In some example embodiments, according to another revenue prediction model corresponding to the post-start and pre-delivery stage (e.g., the stage when the delivery of the campaign has not started), the access module 202 accesses a database table that indicates a projected revenue delivery percentage corresponding to the category into which the campaign is classified based on the status input. One or more further campaigns may also be classified in the category based on having the same status input at the post-start and pre-delivery stage.

The projected revenue delivery percentage may be determined based on historical data pertaining to the delivery of the one or more further campaigns classified in the category. Based on the accessing of the database table, by the access module 202, the revenue prediction module 206 identifies the projected revenue delivery percentage corresponding to the category. The generating of the predicted revenue value may be based on the projected revenue delivery percentage.

In some instances, the campaign is associated with a particular geographical region. One or more further campaigns may also be classified in the category based on having the same status input at the post-start and pre-delivery stage. The access module 202 accesses a database table that indicates a projected revenue delivery percentage corresponding to the category into which the campaign is classified based on the status input. The table may also include information pertaining to the geographical region of the campaigns. The projected revenue delivery percentage is determined based on historical data pertaining to the delivery of one or more further campaigns classified in the category and also associated with the particular geographical region. Based on the accessing of the database table, by the access module 202, the revenue prediction module 206 identifies the projected revenue delivery percentage corresponding to the category and the particular geographical region. The generating of the predicted revenue value may be based on the projected revenue delivery percentage.

In certain example embodiments, according to a further revenue model corresponding to the delivering stage (e.g., the stage when delivery of the campaign has started), the access module 202 accesses a delivered revenue value associated with the campaign and corresponding to a revenue delivered during a particular period of time associated with the campaign. The particular period of time may be the time from the start of ad delivering for the campaign and the present time. The delivered revenue value may be stored in a record of database 218. The revenue prediction module 206 determines a pacing value based on the delivered revenue value and a number of days of campaign delivery during the particular period of time. The pacing value corresponds to an average daily delivered revenue for the campaign during the particular period of time. A different period of time (e.g., seven days, one day, etc.) may be selected for different ad products. Accordingly, the pacing value for a first product may be determined based on a shorter period of time, and the pacing value for a second product may be determined based on a longer period of time. The revenue prediction module 206 may base the generating of the predicted revenue value on the delivered revenue value, the pacing value, and the number of remaining days in the life (e.g., duration) of the campaign. For example, the predicted revenue value equals the sum of the delivered revenue value and the product of the pacing value and the number of remaining days in the life of the campaign.

In some example embodiments, according to yet another revenue prediction model corresponding to the delivery paused stage, the access module 202 accesses a delivered revenue value associated with the campaign and corresponding to a revenue delivered during a particular period of time associated with the campaign. The particular period of time may be the time from the start of ad delivering for the campaign and the time the campaign is paused. The delivered revenue value may be stored in a record of database 218. The access module 202 also accesses a database table that indicates a projected revenue delivery percentage corresponding to the category into which the campaign is classified based on the status input. The projected revenue delivery percentage may be determined based on historical data pertaining to the delivery of one or more further campaigns classified in the category. Based on the accessing of the database table, by the access module 202, the revenue prediction module 206 identifies the projected revenue delivery percentage corresponding to the category. The generating of the predicted revenue value for the campaign based on the stage of the campaign includes generating the predicted revenue value based on the delivered revenue value and the projected revenue delivery percentage.

In certain example embodiments, according to yet a further revenue model corresponding to the delivery post-pause stage (e.g., the stage when delivery of the campaign has been re-started after the campaign has been paused), the access module 202 accesses a delivered revenue value associated with the campaign and corresponding to a revenue delivered during a particular period of time associated with the campaign. The particular period of time may be the time from the start of ad delivering for the campaign and the time that the campaign was paused. The delivered revenue value may be stored in a record of database 218. The revenue prediction module 206 determines a pacing value based on the delivered revenue value and a number of days of campaign delivery during the particular period of time. The pacing value corresponds to an average daily delivered revenue for the campaign during the particular period of time. The generating of the predicted revenue value for the campaign based on the stage of the campaign includes generating the predicted revenue value for the campaign based on the delivered revenue value, the pacing value, and the number of remaining days in the life (e.g., duration) of the campaign. For example, the predicted revenue value equals the sum of the delivered revenue value and the product of the pacing value and the number of remaining days in the life of the campaign.

In certain example embodiments, according to another revenue model corresponding to the end stage (e.g., the stage when delivery of the campaign has ended), the access module 202 accesses a delivered revenue value associated with the campaign and corresponding to a revenue delivered during the life of the campaign. The generating of the predicted revenue value for the campaign based on the stage of the campaign includes generating the predicted revenue value based on the delivered revenue value.

According to some example embodiments, the revenue prediction module 206 determines that the campaign is over-pacing (e.g., delivering ahead of schedule). The determining that the campaign is over-pacing may be based on comparing the delivered revenue and a target revenue for the particular period of time associated with the campaign. Based on the determining that the campaign is over-pacing, the revenue prediction module 206 adjusts the predicted revenue value to correspond to a booked revenue value associated with the campaign.

In some example embodiments, if the campaign has been under-delivering ads, then, for a particular period before the end of the campaign (e.g., two weeks before the end of the campaign), the ad delivery system increases the delivery of ads. Accordingly, for the particular period before the end of the campaign, the revenue prediction module 206, when determining the predicted revenue for each day of the particular period, applies a multiplier (e.g., 1.2) to the average daily revenue value for the last seven days. For example, if the last seven-day average daily revenue value is $1000 and the multiplier is 1.2, then the predicted daily revenue value for each day of the last two weeks of the campaign is $1,200.

The report generation module 214 generates a report that includes the predicted revenue value for the campaign. The report generation module 214 may also generate a report that includes the revenue risk value (e.g., a revenue non-delivery risk value) associated with the campaign. One or more reports including various metrics may be displayed in a user interface of a device associated with an administrator.

Examples of metrics that may be presented in a report include: a revenue non-delivery risk value for the duration of the campaign, a revenue non-delivery risk value for each stage of the life of the campaign, a revenue non-delivery risk value per product, per region, per classification, per manager, per team, business line, per billing method, etc.; a predicted revenue value for the duration of the campaign, a predicted revenue value for each stage of the life of the campaign, a predicted revenue value per product, per region, per classification, per manager, per team, business line, per billing method, etc.

The ranking module 216 ranks a plurality of campaigns based on the predicted revenue value associated with each of the plurality of campaigns.

To perform one or more of its functionalities, the revenue predicting system 200 may communicate with one or more other systems. For example, an integration engine may integrate the revenue predicting system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 218 (e.g., database 128, 130, 132, 136, 138, or 140).

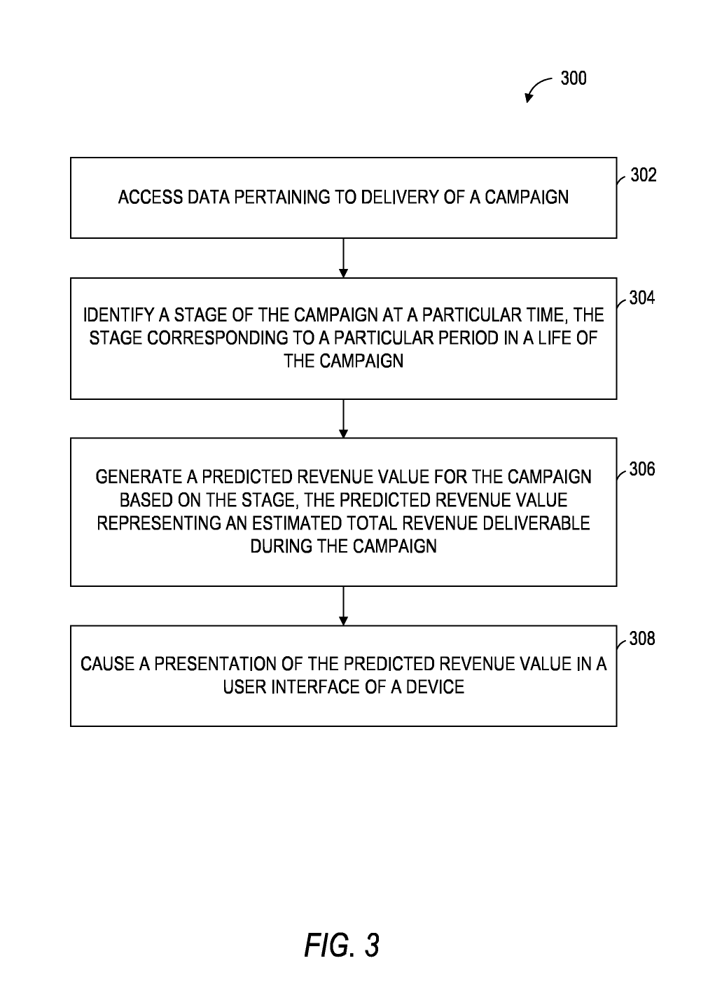

FIGS. 3-9 are flowcharts illustrating a method for predicting online ad revenue of a campaign, according to some example embodiments. The operations of method 300 illustrated in FIG. 3 may be performed using modules described above with respect to FIG. 2. As shown in FIG. 3, method 300 may include one or more of method operations 302, 304, 306, and 308, according to some example embodiments.

At operation 302, the access module 202 accesses data pertaining to delivery of a campaign. The campaign is an online ad campaign including one or more ads to be delivered to one or more users. The one or more users may include one or more members of the social networking service (SNS). The SNS may be the publisher of the ad campaign. The data pertaining to the delivery of the campaign may be stored in a record of database 218.

At operation 304, the stage identifying module 204 identifies a stage of the campaign at a particular time. The stage corresponds to a particular period in a life of the campaign. The identifying of the stage may be based on the data pertaining to the delivery of the campaign.

At operation 306, the revenue prediction module 206 generates a predicted revenue value for the campaign. The generating of the predicted revenue value may be based on the stage of the campaign. The predicted revenue value represents an estimated total revenue deliverable during the campaign.

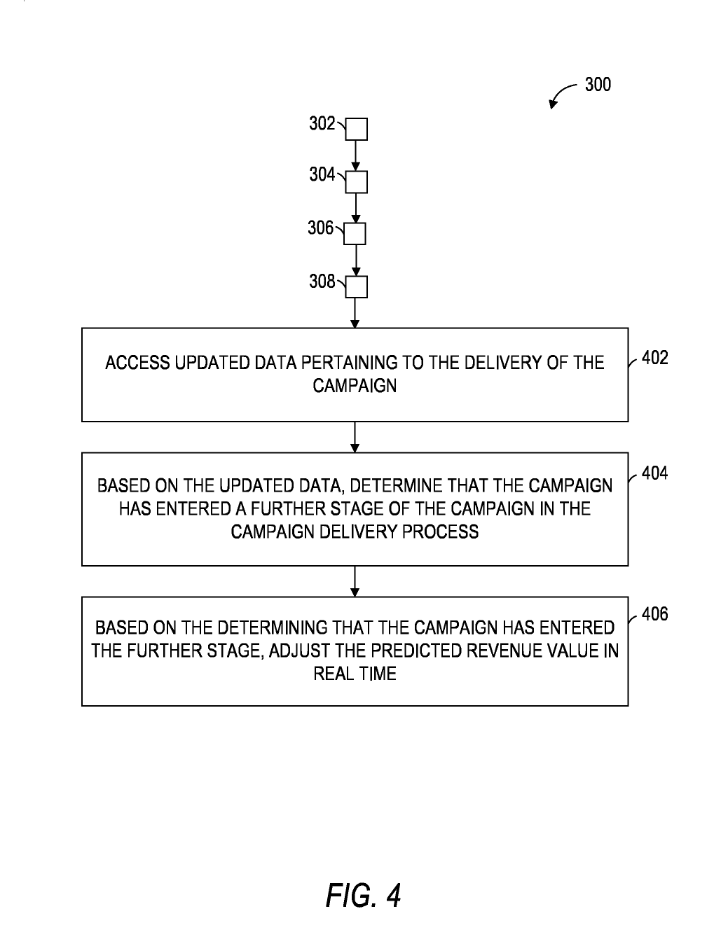

At operation 308, the presentation module 208 causes a presentation (e.g., display) of the predicted revenue value in a user interface of a device associated with an administrator. Further details with respect to the operations of the method 600 are described below with respect to FIGS. 4-9.

As shown in FIG. 4, method 300 may include one or more of operations 402, 404, and 406, according to some example embodiments. Operation 402 may be performed after operation 308, in which the presentation module 208 causes the presentation of the predicted revenue value in the user interface of the device associated with the administrator. At operation 402, the access module 202 accesses updated data pertaining to the delivery of the campaign. The updated data pertaining to the delivery of the campaign may be stored in a record of database 218.

At operation 404, the stage identifying module 204, based on the updated data, determines that the campaign has entered a further stage of the campaign in the campaign delivery process.

At operation 406, the revenue prediction module 206, based on the determining that the campaign has entered the further stage, adjusts the predicted revenue value in real time.

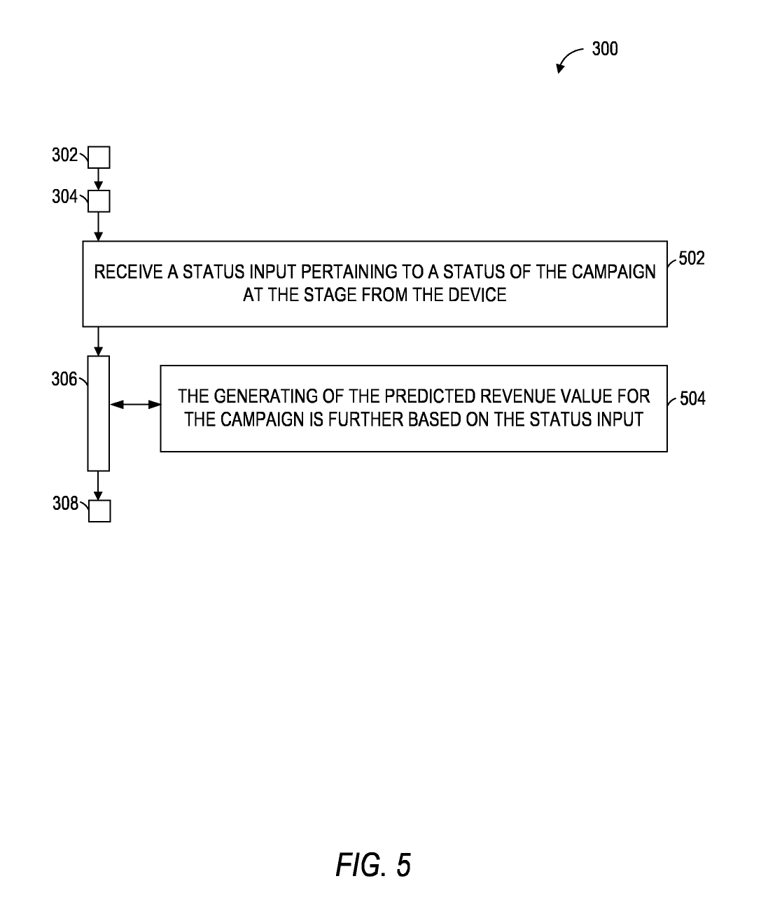

As shown in FIG. 5, method 300 may include one or more of operations 502 and 504, according to some example embodiments. Operation 502 may be performed after operation 304, in which the stage identifying module 204 identifies a stage of the campaign at a particular time. At operation 502, the status input module 210 receives a status input pertaining to a status of the campaign at the stage from the device. The status input may be provided by an administrator via the device associated with the administrator. The status input may identify, in some instances, a reason for a delay of delivery of the one or more ads included in the campaign.

Operation 504 may be performed as part (e.g., a precursor task, a subroutine, or a portion) of method operation 306, in which the revenue prediction module 206 generates a predicted revenue value for the campaign. At operation 504, the revenue prediction module 206 further bases the generating of the predicted revenue value for the campaign on the status input.

According to certain example embodiments, the status input module 210 receives a further status input pertaining to the status of the campaign from the device. The status input module 210 also determines that a change in the status of the campaign has occurred. Based on the determining, by the status input module 210, that the change in the status of the campaign has occurred, the revenue prediction module 206 adjusts the predicted revenue value in real time according to the change of the status of the campaign.

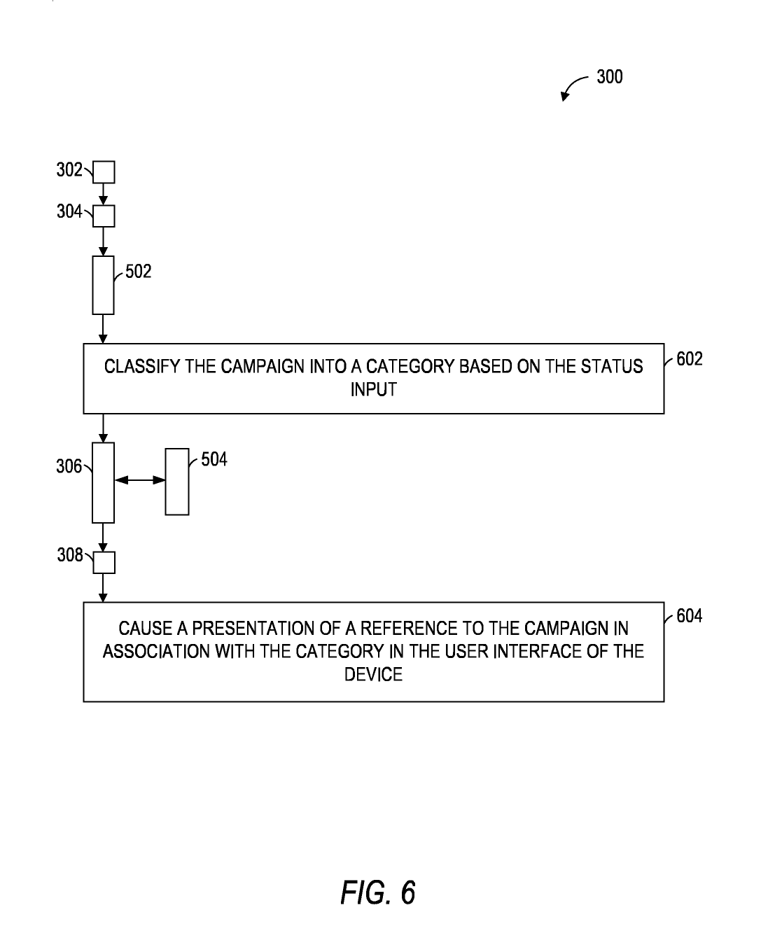

As shown in FIG. 6, method 300 may include one or more of operations 602 and 604, according to some example embodiments. Operation 602 may be performed after operation 502, in which the status input module 210 receives a status input pertaining to the status of the campaign at the stage from the device. At operation 602, the classification module 212 classifies the campaign into a category based on the status input.

Operation 604 may be performed after operation 308, in which the presentation module 208 causes the presentation of the predicted revenue value in the user interface of the device associated with the administrator. At operation 604, the presentation module 208, causes a presentation of a reference to the campaign in association with the category in the user interface of the device.

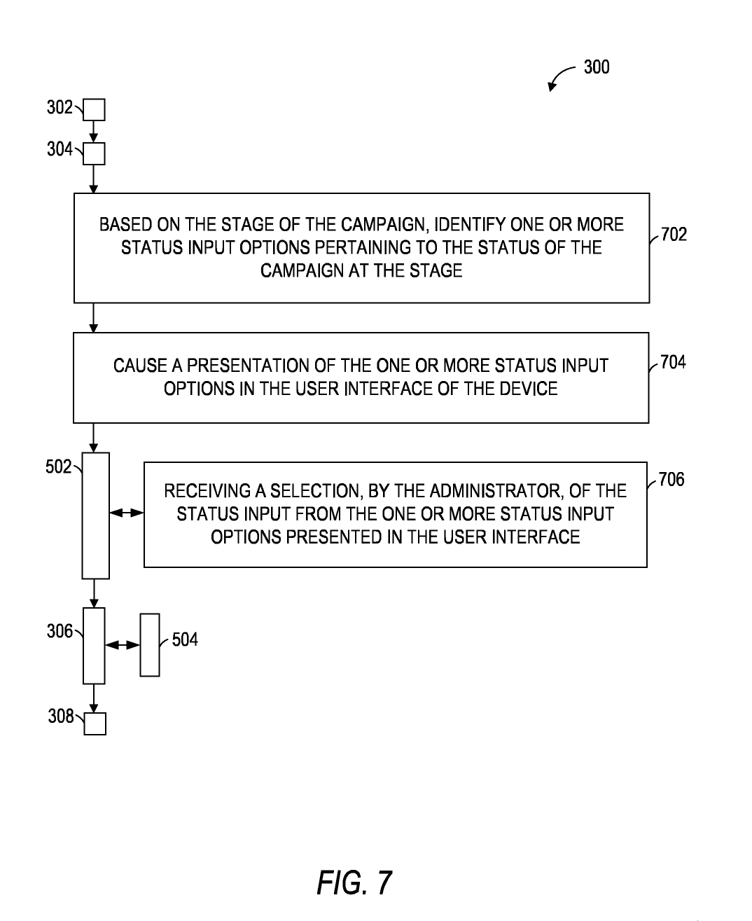

As shown in FIG. 7, method 300 may include one or more of operations 702, 704, and 706, according to some example embodiments. Operation 702 may be performed after operation 304, in which the stage identifying module 204 identifies a stage of the campaign at a particular time.

At operation 702, the status input module 210 identifies one or more status input options pertaining to the status of the campaign at the stage. The identifying of the one or more status input options may be based on the stage of the campaign.

At operation 704, the presentation module 204 causes a presentation of the one or more status input options in the user interface of the device associated with the administrator.

Operation 706 may be performed as part (e.g., a precursor task, a subroutine, or a portion) of operation 502, in which the status input module 210 receives the status input. At operation 706, the receiving of the status input includes receiving a selection, by the administrator, of the status input from the one or more status input options presented in the user interface of the device associated with the administrator.

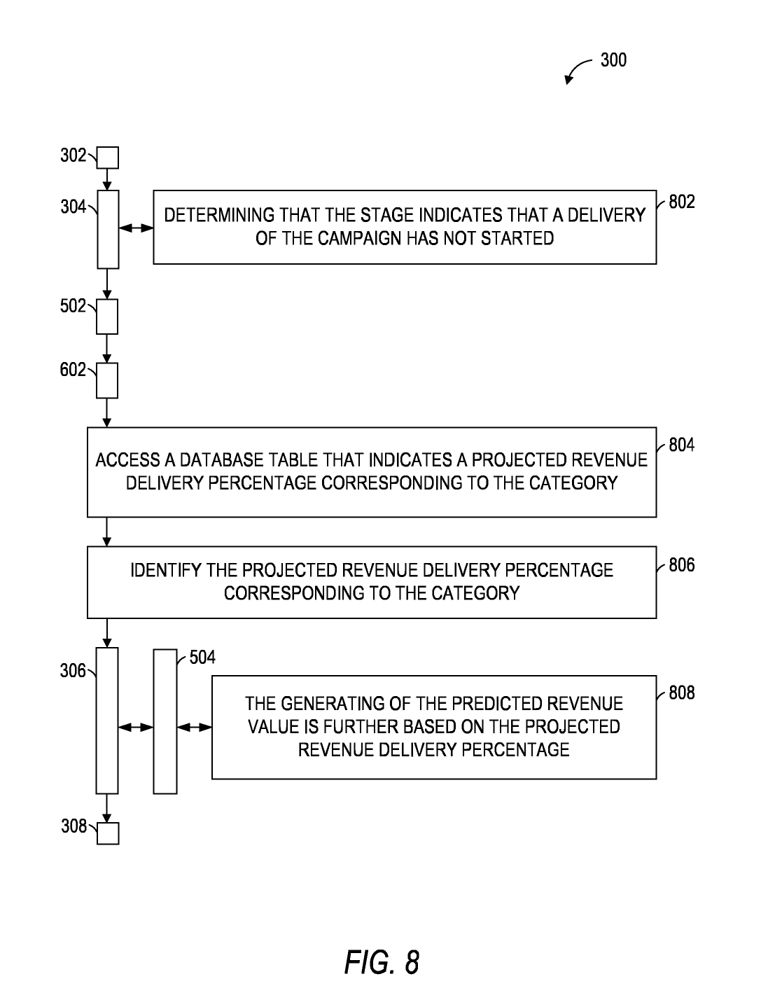

As shown in FIG. 8, method 300 may include one or more of operations 802, 804, 806, and 808, according to some example embodiments. Operation 802 may be performed as part (e.g., a precursor task, a subroutine, or a portion) of operation 304, in which the stage identifying module 204 identifies the stage of the campaign at the particular time. At operation 802, the stage identifying module 204 determines that the stage indicates that a delivery of the campaign has not started.

Operation 804 may be performed after operation 602, in which the classification module 212 classifies the campaign into a category based on the status input. At operation 804, the access module 202 accesses a database table that indicates a projected revenue delivery percentage corresponding to the category. The projected revenue delivery percentage may be determined based on historical data pertaining to the delivery of one or more further campaigns classified in the category.

Operation 806 is performed after operation 804. At operation 806, based on the accessing, by the access module 202, of the database table, the revenue prediction module 206 identifies the projected revenue delivery percentage corresponding to the category.

Operation 808 is performed as part (e.g., a precursor task, a subroutine, or a portion) of operation 504, in which the revenue prediction module 206 further bases the generating of the predicted revenue value for the campaign on the status input. At operation 808, the revenue prediction module 206 further bases the generating of the predicted revenue value for the campaign on the projected revenue delivery percentage.

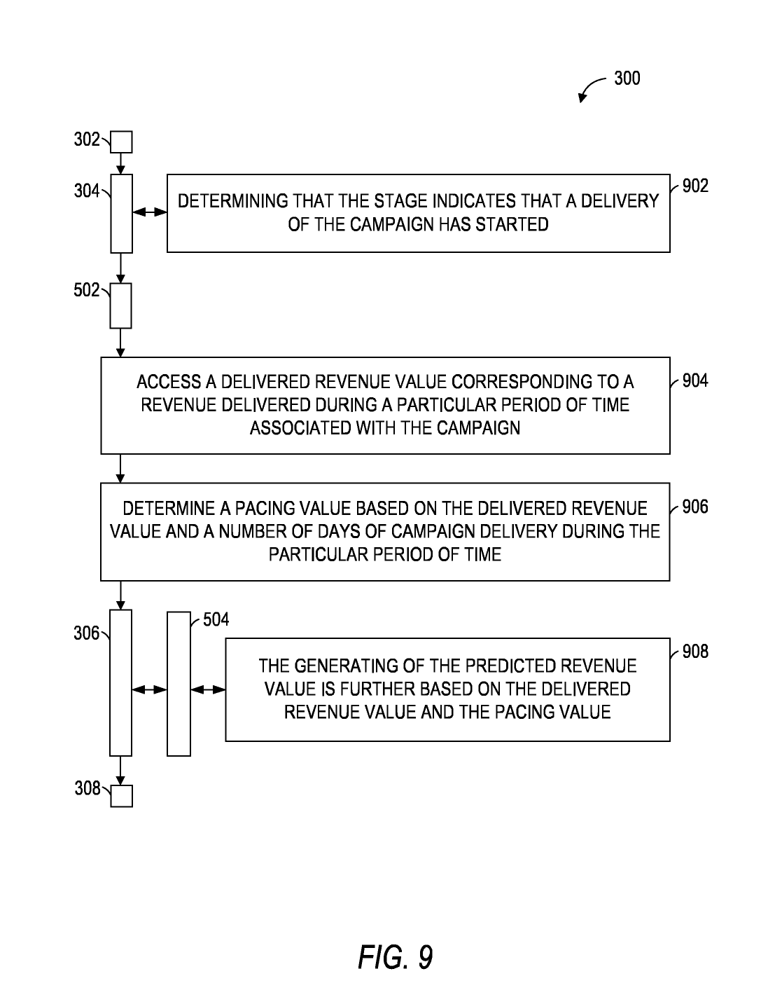

As shown in FIG. 9, method 300 may include one or more of operations 902, 904, 906, and 908, according to some example embodiments. Operation 902 may be performed as part (e.g., a precursor task, a subroutine, or a portion) of operation 304, in which the stage identifying module 204 identifies the stage of the campaign at the particular time. At operation 802, the stage identifying module 204 determines that the stage indicates that a delivery of the campaign has started.

Operation 904 may be performed after operation 502, in which the status input module 210 receives a status input pertaining to a status of the campaign at the stage from the device. At operation 904, the access module 202 accesses a delivered revenue value associated with the campaign and corresponding to a revenue delivered during a particular period of time associated with the campaign. The delivered revenue value may be stored in a record of database 218.

At operation 906, the revenue prediction module 206 determines a pacing value based on the delivered revenue value and a number of days of campaign delivery during the particular period of time. The pacing value corresponds to an average daily delivered revenue for the campaign during the particular period of time.

Operation 908 may be performed as part (e.g., a precursor task, a subroutine, or a portion) of operation 504, in which the revenue prediction module 206 further bases the generating of the predicted revenue value for the campaign on the status input. At operation 908, the revenue prediction module 206 further bases the generating of the predicted revenue value for the campaign on the delivered revenue value and the pacing value.

According to some example embodiments, the revenue prediction module 206 determines that the campaign is over-pacing (e.g., delivering ahead of schedule). The determining that the campaign is over-pacing may be based on comparing the delivered revenue and a target revenue for the particular period of time associated with the campaign. Based on the determining that the campaign is over-pacing, the revenue prediction module 206 adjusts the predicted revenue value to correspond to a booked revenue value associated with the campaign.

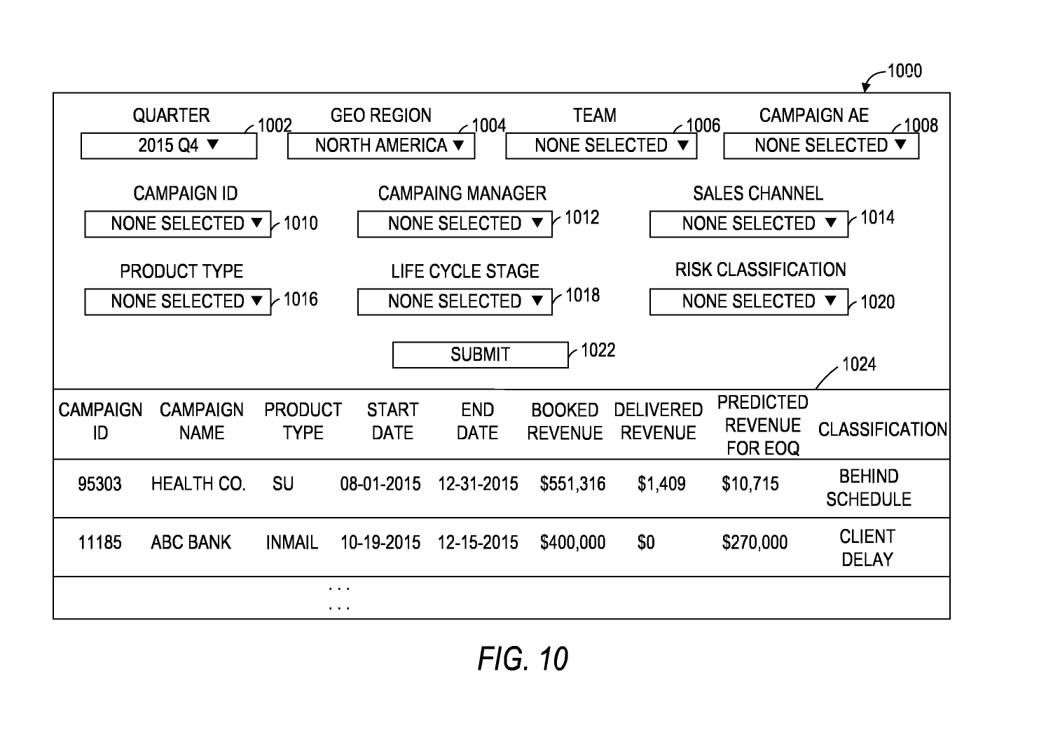

FIG. 10 is a diagram 1000 illustrating a user interface displaying filters applicable to campaign data of one or more campaigns, and a revenue report for one or more campaigns, according to some example embodiments. As discussed above, the revenue predicting system 200 may cause the presentation of one or more revenue values associated with the customer in a user interface of a device. Additionally or alternatively, the revenue predicting system 200 may cause the presentation of various types of information related to online ad campaigns or advertisers, types of ad products (e.g., Sponsored Updates, InMail, Displayed Ads, etc), and metrics pertaining to the sale of advertising, delivery of advertising, forecasting of revenue delivery, etc.

In some example embodiments, as shown in FIG. 10, the user interface may present a number of drop-down menu areas. Example of such drop-down menu areas are quarter menu 1002, geographical region menu 1004, team menu 1006, campaign Account Executive (“AE”) menu 1008, campaign identifier (“ID”) menu 1010, campaign manager menu 1012, sales channel menu 1014, product type menu 1016, life cycle stage menu 1018, and risk classification menu 1020. An administrator (e.g., a campaign AE, a campaign manager, etc.) may click on any of these menus, view the displayed options associated with the particular menu, and select an option to requesting the filtering of campaign data according to the selected menu option. For example, the administrator may select option “2015 Q4” from the options associated with the quarter menu 1002, as shown in FIG. 10, to view revenue-related data for the fourth quarter of 2015 for one or more campaigns. In addition, as shown in FIG. 10, the administrator may select option “North America” from the options associated with the geographical region menu 1004 to limit the displayed data to campaigns run in North America.

In some example embodiments, as shown in FIG. 10, the user interface may present a revenue report 1024 for one or more online ad campaigns run by the publisher on behalf of one or more advertisers. As illustrated in FIG. 10, the revenue report 1024 may display various information related to one or more campaigns. For example, for a campaign that has the campaign ID “95303,” the revenue report 1024 shows the campaign name “Health Co.,” the product type “Sponsored Update” (“SU”), the start date “08-01-2015,” the end date “12-31-2015,” the booked revenue value “$551,316,” the delivered revenue value “$1,409,” the predicted revenue for the end-of-quarter (“EOQ”) “$10,715,” and the classification “Behind Schedule.” According to another example, for a campaign that has the campaign ID “11185,” the revenue report 1024 shows the campaign name “ABC Bank,” the product type “InMail,” the start date “10-19-2015,” the end date “12-15-2015,” the booked revenue value “$400,000,” the delivered revenue value “$0,” the predicted revenue for the end-of-quarter (“EOQ”) “$270,000,” and the classification “Client Delay.”

### Example Mobile Device

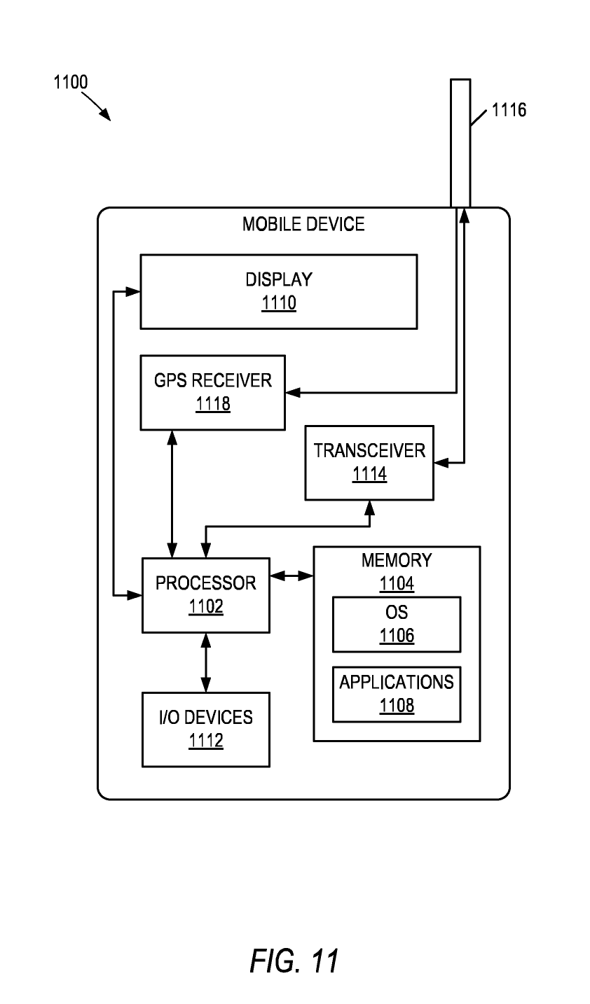

FIG. 11 is a block diagram illustrating a mobile device 1100, according to an example embodiment. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

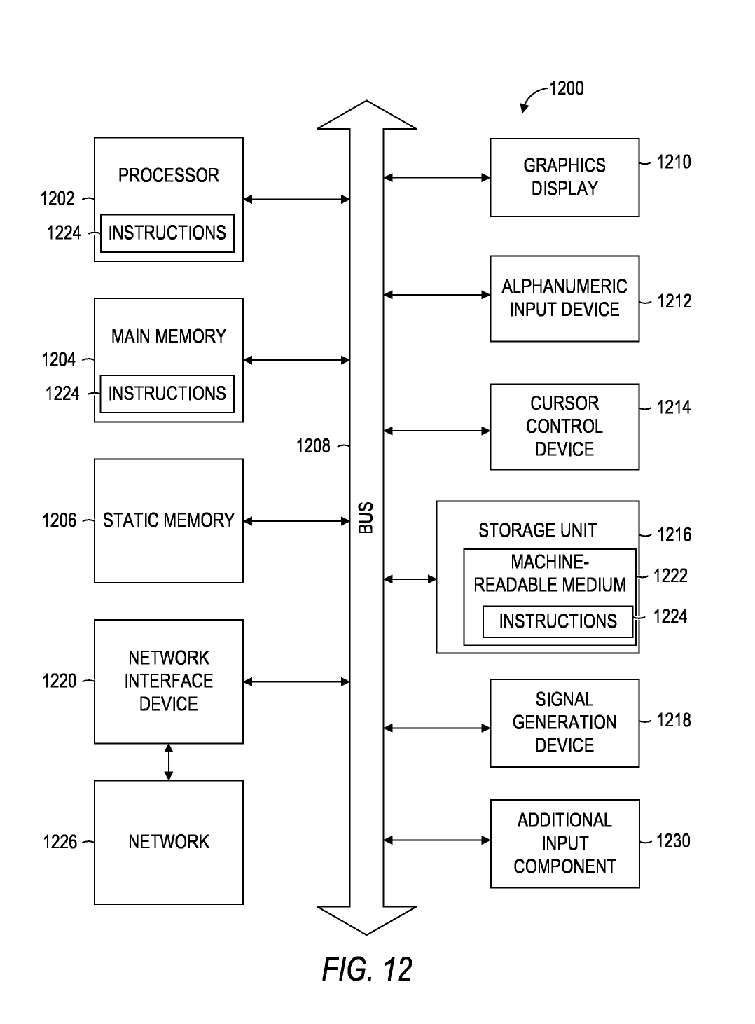

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing data pertaining to delivery of a campaign, the campaign being an online ad campaign including one or more ads to be delivered to one or more users;
identifying a stage of the campaign at a particular time based on the data pertaining to the delivery of the campaign, the stage corresponding to a particular period in a life of the campaign;
generating, using one or more hardware processors, a predicted revenue value for the campaign based on the stage of the campaign, the predicted revenue value representing an estimated total revenue deliverable during the campaign; and
causing a presentation of the predicted revenue value in a user interface of a device associated with an administrator.

2. The method of claim 1, further comprising:
accessing updated data pertaining to the delivery of the campaign;
based on the updated data, determining that the campaign has entered a further stage of the campaign in the campaign delivery process; and
based on the determining that the campaign has entered the further stage, adjusting the predicted revenue value in real time.

3. The method of claim 1, further comprising:
receiving a status input pertaining to a status of the campaign at the stage from the device, wherein
the generating of the predicted revenue value for the campaign is further based on the status input.

4. The method of claim 3, further comprising:
classifying the campaign into a category based on the status input; and
causing a presentation of a reference to the campaign in association with the category in the user interface of the device.

5. The method of claim 4, wherein the identifying of the stage includes determining that the stage indicates that a delivery of the campaign has not started, the method further comprising:
accessing a database table that indicates a projected revenue delivery percentage corresponding to the category, the projected revenue delivery percentage being determined based on historical data pertaining to delivery of one or more further campaigns classified in the category; and
based on the accessing of the database table, identifying the projected revenue delivery percentage corresponding to the category, wherein
the generating of the predicted revenue value is further based on the projected revenue delivery percentage.

6. The method of claim 3, wherein the status input identifies a reason for a delay of delivery of the one or more ads included in the campaign.

7. The method of claim 3, further comprising:
based on the stage of the campaign, identifying one or more status input options pertaining to the status of the campaign at the stage; and
causing a presentation of the one or more status input options in the user interface of the device, wherein
receiving the status input includes receiving a selection of the status input from the one or more status input options presented in the user interface.

8. The method of claim 3, further comprising:
receiving a further status input pertaining to the status of the campaign from the device;
based on the further status input, determining that a change in the status of the campaign has occurred; and
based on the determining that the change in the status of the campaign has occurred, adjusting the predicted revenue value in real time according to the change of the status of the campaign.

9. The method of claim 1, wherein the identifying of the stage includes determining that the stage indicates that a delivery of the campaign has started, the method further comprising:
accessing a delivered revenue value corresponding to a revenue delivered during a particular period of time associated with the campaign; and
determining a pacing value based on the delivered revenue value and a number of days of campaign delivery during the particular period of time, the pacing value corresponding to an average daily delivered revenue for the campaign during the particular period of time, wherein
the generating of the predicted revenue value is further based on the delivered revenue value, the pacing value, and a number of days remaining in the life of the campaign.

10. The method of claim 9, further comprising:
determining that the campaign is over-pacing based on comparing the delivered revenue and a target revenue for the particular period of time associated with the campaign; and
based on the determining that the campaign is over-pacing, adjusting the predicted revenue value to correspond to a booked revenue value associated with the campaign.

11. The method of claim 1, wherein the identifying of the stage includes determining that the stage indicates that the campaign has not started, the method further comprising:
determining, based on data describing the campaign, a type of ad product included in the campaign;
determining, based on the data describing the campaign, a geographical region associated with the campaign; and
based on the type of campaign and the geographical region, determining an average daily delivery value for a particular period of time for one or more further campaigns associated with the type of ad product and the geographical region, wherein
the generating of the predicted revenue value for the campaign based on the stage of the campaign includes generating the predicted revenue value for the campaign based on the average daily delivery value for the particular period of time.

12. The method of claim 1, wherein the identifying of the stage includes determining that the stage indicates that the campaign has been paused, the method further comprising:
accessing a delivered revenue value associated with the campaign and corresponding to a revenue delivered during a particular period of time associated with the campaign;
accessing a database table that indicates a projected revenue delivery percentage corresponding to the category; and
based on the accessing of the database table, identifying the projected revenue delivery percentage corresponding to the category, wherein
the generating of the predicted revenue value for the campaign based on the stage of the campaign includes generating of the predicted revenue value based on the delivered revenue value and the projected revenue delivery percentage.

13. The method of claim 1, wherein the identifying of the stage includes determining that the stage indicates that the campaign has been re-started after the campaign has been paused, the method further comprising:
accessing a delivered revenue value associated with the campaign and corresponding to a revenue delivered during a particular period of time associated with the campaign; and
determining a pacing value based on the delivered revenue value and a number of days of campaign delivery during the particular period of time, the pacing value corresponding to an average daily delivered revenue for the campaign during the particular period of time, wherein
the generating of the predicted revenue value for the campaign based on the stage of the campaign includes generating the predicted revenue value for the campaign based on the delivered revenue value, the pacing value, and the number of remaining days in the life of the campaign.

14. The method of claim 1, wherein the identifying of the stage includes determining that the stage indicates that the campaign has ended, the method further comprising:
accessing a delivered revenue value associated with the campaign and corresponding to a revenue delivered during the life of the campaign, wherein
the generating of the predicted revenue value for the campaign based on the stage of the campaign includes generating the predicted revenue value based on the delivered revenue value.

15. A system comprising:
a machine-readable medium for storing instructions that, when executed by one or more hardware processors, cause the system to perform operations comprising:
accessing data pertaining to delivery of a campaign, the campaign being an online ad campaign including one or more ads to be delivered to one or more users;
identifying a stage of the campaign at a particular time based on the data pertaining to the delivery of the campaign, the stage corresponding to a particular period in a life of the campaign;
generating, using one or more hardware processors, a predicted revenue value for the campaign based on the stage of the campaign, the predicted revenue value representing an estimated total revenue deliverable during the campaign; and
causing a presentation of the predicted revenue value in a user interface of a device associated with an administrator.

16. The system of claim 15, wherein the operations further comprise:
receiving a status input pertaining to a status of the campaign at the stage from the device, wherein
the generating of the predicted revenue value for the campaign is further based on the status input.

17. The system of claim 16, wherein the operations further comprise:
classifying the campaign into a category based on the status input; and
causing a presentation of a reference to the campaign in association with the category in the user interface of the device.

18. The system of claim 17, wherein the identifying of the stage includes determining that the stage indicates that a delivery of the campaign has not started, and the operations further comprise:
accessing a database table that indicates a projected revenue delivery percentage corresponding to the category, the projected revenue delivery percentage being determined based on historical data pertaining to delivery of one or more further campaigns classified in the category; and
based on the accessing of the database table, identifying the projected revenue delivery percentage corresponding to the category, wherein
the generating of the predicted revenue value is further based on the projected revenue delivery percentage.

19. The system of claim 15, wherein the identifying of the stage includes determining that the stage indicates that a delivery of the campaign has started, and the operations further comprise:
accessing a delivered revenue value corresponding to a revenue delivered during a particular period of time associated with the campaign; and
determining a pacing value based on the delivered revenue value and a number of days of campaign delivery during the particular period of time, the pacing value corresponding to an average daily delivered revenue for the campaign during the particular period of time, wherein
the generating of the predicted revenue value is further based on the delivered revenue value, the pacing value, and a number of days remaining in the life of the campaign.

20. A non-transitory machine-readable storage medium comprising instructions that, when executed by one or more processors of a machine, cause the machine to perform operations comprising:
accessing data pertaining to delivery of a campaign, the campaign being an online ad campaign including one or more ads to be delivered to one or more users;
identifying a stage of the campaign at a particular time based on the data pertaining to the delivery of the campaign, the stage corresponding to a particular period in a life of the campaign;
generating, using one or more hardware processors, a predicted revenue value for the campaign based on the stage of the campaign, the predicted revenue value representing an estimated total revenue deliverable during the campaign; and
causing a presentation of the predicted revenue value in a user interface of a device associated with an administrator.
